(19) United States
(12) Patent Application Publication
(10) Pub. No.: US 2009/0269547 A1
(43) Pub. Date: Oct. 29, 2009

(54) REPAIR OF HONEYCOMB STRUCTURES

(75) Inventors: Francis Meyer, Haguenau (FR); Gleyal Sylvain, Wasselonne (FR)

Correspondence Address: DOBRUSIN & THENNISCH PC, 29 W LAWRENCE ST, SUITE 210, PONTIAC, MI, 48342, US

(73) Assignee: Zephyros, Inc., Romeo, MI (US)

(21) Appl. No.: 12/303,011

(22) PCT Filed: May 29, 2007
(86) PCT No.: PCT/US2007/004740

§ 371 Date: Jun. 24, 2009

(30) Foreign Application Priority Data
May 31, 2006 (GB) 0610695.9

(51) Int. Cl. B32B 3/12; B32B 43/00

(52) U.S. Cl. 428/116; 156/94

(57) ABSTRACT

A process for the repair of a honeycomb structure which comprises a honeycomb bonded to at least one surface layer wherein a replacement for a damaged piece of the structure is bonded to the honeycomb structure by means of a foamable adhesive material.

The present invention relates to improvements in or relating to composite structures and in particular honeycomb structures and more particularly to the bonding together of two honeycomb structures. In a preferred embodiment the invention provides a simple technique for the repair of honeycomb structures. Honeycomb structures are widely used as lightweight materials to provide strength particularly in transportation vehicles such as aircraft, motor vehicles, trains, boats, ships and in aerospace.

Honeycomb structures are typically made from two skins or facing panels which enclose the honeycomb which may be of any lightweight material aluminum or impregnated paper are the preferred materials.

One difficulty with composite structures and in particular honeycomb structures is that they are difficult to repair. For example with a composite structure an impact at a single point on the surface of a structure can be transmitted within the structure to cause distortion and perhaps breakage over a large area and/or to some depth within the structure. It is however important that the structure can be repaired to provide the same strength and performance as the original article and the repair must support applied loads and transmit applied loads across the repaired area. Various techniques have been proposed for the repair of composite structures, including honeycomb structures. One method involves cutting out the damaged area and replacing it with filler plies which are then bonded to the exposed surface of the laminate. This method suffers from the disadvantages that the repaired structure is generally thicker and heavier than the original structure and good adhesion between the replacement material and the original structure is difficult to achieve. Other methods include careful and precise cutting away of the damaged area to provide a tapered surface so that each ply of the structure can be replaced individually. This is an extremely laborious and complicated procedure to perform.

There is therefore a need for a simple and effective method for the repair of composite structures which minimizes the increase in weight caused by the repair, which repairs the structure of the composite structure that has been damaged and which can return the structure to its original strength.

We have now found that foamable adhesive materials are particularly useful for bonding together composite structural materials and, in particular they are particularly useful for the bonding of replacement pieces of honeycomb structures for repair purposes.

The present invention therefore provides the use of a foamable adhesive material for the bonding together of honeycomb structures.

In a preferred embodiment of the invention the foamable adhesive material is a material that foams and cures under the application of heat.

In a further preferred embodiment the invention provides for the repair of composite honeycomb structures which comprise a honeycomb bonded to at least one surface layer whereby a replacement for a damaged piece of the structure is bonded to the honeycomb structure and is also bonded to a replacement piece of the surface layer by means of a foamable adhesive material.

In a further embodiment the foamable adhesive is a material that is flexible and can be readily processed prior to curing and foaming and forms a rigid foam upon curing. The use of such a material enables the provision of a repair material comprising a patch of the composite material of the appropriate size enclosed by the foamable material. The repair material may be placed in the cavity around the damaged area and the repair effected by foaming and curing the foamable material to form a strong bond between the patch and the original structure.

In a preferred embodiment in which the composite structure compromises a honeycomb provided with one or more surface panels a second patch for the repair of the surface panel can be provided which can be placed on top of the foamable adhesive material that encloses the patch of the composite material so that the surface repair portion also becomes bonded to the replacement patch by the foamed and cured adhesive material. If desired the second patch can be sized to that as the foamable material foams it can pass between edges of the surface patch and the original surface material and can cure to form a bond between the two. Two such patches may be employed if the repair is effected across the entire depth of the composite structure.

It is contemplated that the panel structure of the invention may be derived from a variety of articles. Exemplary articles include household or industrial appliance (e.g., dishwashers, washing machines, dryers or the like), furniture, storage containers or the like. In one embodiment, the panel structure is employed in a transportation vehicle (e.g., an automotive vehicle, a boat, an airplane or the like). When used for a transportation vehicle, the panel structure has been found to be particularly useful panel structure of an aerospace vehicle (e.g., an airplane). As such, the panel structure of the present invention is primarily discussed in relation to an airplane, however, the invention should not be so limited unless otherwise stated.

The facing sheet of the structure may be formed of a variety of materials. Exemplary materials include metals, polymeric materials (e.g., plastics, elastomers, thermoplastics, thermosets, combinations thereof or the like). The materials of the panels may also be reinforced with minerals, fibrous materials (e.g., glass, carbon or nylon fibers), combinations thereof or the like. In one embodiment, one facing sheet is formed of fiberglass/plastic composite and another is formed of a metal or metal alloy.

### The Material

The foamable material used in the present invention is typically selected so as to be activatable under a desired condition. As used herein, activatable means that the material softens (e.g., melts), cures, expands, foams or a combination thereof upon exposure to a condition or upon the combination of particular chemicals (e.g., 2-component materials).

In a preferred embodiment, the material has a post-cure glass transition temperature that is greater than any temperatures to which the material may be exposed while in its intended environment of use (e.g., in an airplane or automotive vehicle). Exemplary post-cure glass transition temperatures may be greater than about 80 degrees Celsius and more preferably greater than about 100 degrees Celsius. Other desired characteristics of the material might include good adhesion retention and degradation resistance particularly in adverse environments such as highly variable temperature environments, high dynamic activity environments, combinations thereof or the like. For particular embodiments (e.g., where damping or sound absorption is desired), the material may stay in a softer or goopy state or it may become more solid particularly if it has a lower post-cure glass transition temperature.

The material may be a thermoplastic, a thermoset or a blend thereof. According to one embodiment, the material is as an epoxy-containing material, an ethylene-containing polymer, an acetate or acrylate containing polymer, or a mixture thereof, which when compounded with appropriate ingredients (typically a blowing agent, a curing agent, and perhaps a filler), typically expands, cures or both in a reliable and predictable manner upon the application of heat or another activation stimulus. Thus, according to one preferred embodiment, an exemplary material may be a heat-activated and/or epoxy-based resin having foamable characteristics. Of course, the material may be activated by other conditions or stimuli. Generally, it is contemplated that, particularly for higher expansion materials, the activatable material may include or be based upon an elastomer (e.g., rubber), an acetate, an acrylate or combinations thereof.

From a chemical standpoint for a thermally-activated material, such material is usually initially processed as a thermoplastic material before curing. After curing, the material typically becomes a thermoset material that is fixed and incapable of any substantial flow. Examples of preferred formulations that are commercially available include those available from L&L Products, Inc. of Romeo, Mich., under the designations L-0502, L-0504, L-1066, L-2105, L-2190 L-2663, L-5204, L-5206, L-5207, L-5208, L-5214, L-5218, L-5222, L-5248, L-6000, L-7102, L-7220, L-8000, L-8100, L-8110, L-8115, L-9000 or combinations thereof. It is also contemplated that the material may have a fiberglass or other fabric material integrated to one or more sides of the material and/or within the material.

In applications where the material is a heat activated material, such as when a thermally melting, expanding, curing and/or foaming material is employed, an important consideration involved with the selection and formulation of the material can be the temperature at which the material activates, cures or both. In most applications, it is undesirable for the material to activate at room temperature or the ambient temperature in a production or assembly environment. Typically, it is desirable for the material to activate at higher processing temperatures. Typical activation temperature[s] is at least about 120° F. or less, more typically at least about 190° F., still more typically at least about 230° F. and even more typically at least about 265° F. and typically less than about 600° F. or greater, more typically less than about 450° F. and even more typically less than about 350° F. and still more typically less than about 275° F. Exposure to such temperatures typically occurs for a period of time that is at least about 10 minutes or less, more typically at least about 20 minutes and even more typically at least about 30 minutes and typically less than about 300 minutes or greater, more typically less than about 180 minutes and even more typically less than about 90 minutes.

Although the material may be heat activated, it may be otherwise additionally or alternatively activated by other stimuli to cure, expand, bond, combinations thereof or the like. Without limitation, such material may be activated by alternative stimuli such as, pressure, moisture, chemicals, ultraviolet radiation, electron beam, induction, electromagnetic radiation or by other ambient conditions. As particular examples, the material may be a two-component adhesive material that expand, cure, adhere or a combination thereof upon adding one component to the other. Examples of first component/second component materials include epoxy/amine materials and epoxy/acid materials.

In a preferred embodiment, the foamable material is heat activated in a panel press. The panel structure containing the repair material is fed to a panel press where it experiences temperatures that are typically above about 150° F., more typically above about 200° F. and even more typically above about 265° F. and below about 550° F., more typically below about 420° F. and even more typically below about 350° F., which cause the material to foam and effect the band. Such exposure is typically for a time period of at least about 10 minutes, more typically at least about 30 minutes and even more typically at least about 60 minutes and less than about 360 minutes more typically less than about 180 minutes and even more typically less than about 90 minutes. While in the press, a pressure is typically applied to the panel structure urging the components of the panel structure toward each other. Advantageously, typically for reinforcement, the material can provide more thorough adhesion to the support.

It is additionally contemplated that other additional or alternative techniques may be used to assist in the repair of the panel structure. Such techniques can include vacuum forming and baking, autoclaving and pressure, others or combinations thereof. Such techniques can assist in forming panels with contours. Heats and time period for these techniques can be the same as those discussing above or may be different depending upon the activatable material used.

It is preferred that the foamable volumetrically expand at least 10%, more typically at least 30% and even more typically 100% more than the expansion of the material on the sides. As used herein, a material that expands to a volume that is 210% of its original unexpanded volume volumetrically expands 10% more than a material that expands to 200% of its original volume, and similar calculations may be made for the other percentages.

In one particular embodiment, one singular mass or multiple masses in the form of strips of activatable material are pressed against the honeycomb and/or the one or more panels such that strips attach to the components because of adhesive properties of the activatable material, deformation of the activatable material upon pressing or both. It is also contemplated that the strips of activatable material may be contoured (e.g., bent) about contours of the one or more panels and or the honeycomb (particularly the outer edge of the honeycomb) during pressing or manual application. In such an embodiment, it is typically desirable for the strip[s] of activatable material to be sufficiently flexible to allow bending of the strip[s] from a first straight or linear condition or shape to a second angled or arced condition or shape (e.g., such that one portion of the strip is at an angle a right angle) relative to another portion) without significant tearing or cracking of the strip (e.g., tearing or cracking that destroy the continuity of the strip or pull one part of the strip away from another part).

For allowing application of the activatable material according to the aforementioned protocols, particularly the manual applications, although the automated and applicator techniques may be used as well, it is typically desirable for the activatable material to exhibit certain desirable properties. As suggested, it is generally desirable for the activatable material, prior to activation, to be generally flexible or ductile. After activation of the expandable material, it is preferable, although not required, for the expanded material (e.g., foam) to have relatively high strength. Accordingly, the activated material will typically have a compressive modulus that is greater than about 100 MPa, more typically greater than about 300 MPa and even more typically greater than about 550 MPa (e.g., about 614 MPa) when testing is done in accordance with ASTM D-695. The activated material will also typically have a compressive strength of greater than about 700 psi, more typically greater than 1500 psi and even more particularly greater than 2000 psi when testing is done in accordance with ASTM D-695. Of course, lower moduli and strengths may be employed for the present invention, unless otherwise stated.

Activatable materials having one or any combination of the aforementioned properties have been formulated and it has been found that admixtures having particular ingredients or features are particularly desirable.

The activatable or foamable material typically includes one or more polymeric materials, which may include a variety of different polymers, such as thermoplastics, elastomers, plastomers combinations thereof or the like. For example, and without limitation, polymers that might be appropriately incorporated into the polymeric admixture include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene)polystyrene, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

The polymeric admixture can comprise up to 85% by weight or greater or the activatable material. Preferably, the polymeric admixture comprises about 0.1% to about 85%, more preferably about 1% to about 70% by weight of the activatable material.

### Epoxy Resin

Epoxy resin is used herein to mean any of the conventional dimeric, oligomeric or polymeric epoxy materials containing at least one epoxy functional group. The polymer-based materials may be epoxy containing materials having one or more oxirane rings polymerizable by a ring opening reaction. It is contemplated that the activatable material can include up to about 80% of an epoxy resin or more. Typically, the activatable material includes between about 5% and 60% by weight epoxy resin and still more typically between about 10% and 30% by weight epoxy resin.

The epoxy may be aliphatic, cycloaliphatic, aromatic or the like. The epoxy may be supplied as a solid (e.g., as pellets, chunks, pieces or the like) or a liquid (e.g., an epoxy resin). The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Preferably, an epoxy resin is added to the activatable material to increase adhesion properties of the material. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive.

### Elastomeric Material

Activatable materials used in the present invention, particularly when used in structures for sound reduction (e.g., sound attenuation and or sound absorption), insulation or both, will typically include a substantial amount of elastomeric or rubber material, which can be one elastomer or a mixture of several different elastomers. When used, the elastomeric material is typically at least about 5%, more typically at least about 14%, even more typically at least 25% by weight of the activatable material and the elastomeric material is typically less than about 65%, more typically less than about 45% and even more typically less than about 35% by weight of the activatable material.

Rubbers and elastomers suitable for the elastomeric material include, without limitation, natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene monomer rubbers), chlorosulphonated polyethylene, fluorinated hydrocarbons and the like. Particularly preferred elastomers are EPDMs sold under the tradename VISTALON 7800 and 2504, commercially available from Exxon Mobil Chemical. Another preferred elastomer is a polybutene isobutylene butylenes copolymer sold under the tradename H-1500, commercially available from BP Amoco Chemicals.

### Elastomer-Containing Adduct

An elastomer-containing adduct can also be employed in the activatable material of the present invention such as an epoxy/elastomer adduct. The epoxy/elastomer hybrid or reaction product may be included in an amount of up to about 80% by weight of the activatable material or more. More typically, the elastomer-containing adduct, when included, is approximately 20 to 80%, and more preferably is about 30% to 70% by weight of the activatable material.

In turn, the adduct itself generally includes about 1:5 to 5:1 parts of epoxy to elastomer, and more preferably about 1:3 to 3:1 parts or epoxy to elastomer. The elastomer compound may be a thermosetting or other elastomer. Exemplary elastomers include, without limitation natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. In one embodiment, recycled tire rubber is employed.

The elastomer-containing adduct, when added to the activatable material, preferably is added to modify structural properties of the material such as strength, toughness, stiffness, flexural modulus, or the like. Additionally, the elastomer-containing adduct may be selected to render the activatable material more compatible with coatings such as water-borne paint or primer system or other conventional coatings.

### Blowing Agent

One or more blowing agents may be added to the activatable material. Such blowing agents can assist in forming cellular or foamed activated materials, which typically have a lower density and/or weight. In addition, the material expansion that can be caused by the blowing agents can help to improve sealing capability, substrate wetting ability, adhesion to a substrate, acoustic damping, combinations thereof or the like.

The blowing agent may be a physical blowing agent or a chemical blowing agent. For example, the blowing agent may be a thermoplastic encapsulated solvent that expands upon exposure to a condition such as heat. Alternatively, the blowing agent may chemically react to liberate gas upon exposure to a condition such as heat or humidity or upon exposure to another chemical reactant.

The blowing agent may include one or more nitrogen containing groups such as amides, amines and the like. Examples of suitable blowing agents include azodicarbonamide, dinitrosopentamethylenetetramine, 4,4′-oxy-bis-(benzenesulphonylhydrazide), trihydrazinotriazine and N,Nᵢ-dimethyl-N,Nᵢ-dinitrosoterephthalamide.

An accelerator for the blowing agents may also be provided in the activatable material. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles or imidazoles, ureas or the like.

Amounts of blowing agents and blowing agent accelerators can vary widely within the activatable material depending upon the type of cellular structure desired, the desired amount of expansion of the expandable material, the desired rate of expansion and the like. Exemplary ranges for the amounts of blowing agents and blowing agent accelerators in the activatable material range from about 0.001% by weight to about 5% by weight.

### Curing Agent

One or more curing agents and/or curing agent accelerators may be added to the activatable material. Amounts of curing agents and curing agent accelerators can, like the blowing agents, vary widely within the activatable material depending upon the type of cellular structure desired, the desired amount of expansion of the activatable material, the desired rate of expansion, the desired structural properties of the activatable material and the like. Exemplary ranges for the curing agents or curing agent accelerators present in the activatable material range from about 0.001% by weight to about 7% by weight.

Typically, the curing agents assist the activatable material in curing by crosslinking of the polymers, epoxy resins or both. It can also be desirable for the curing agents to assist in thermosetting the activatable material. Useful classes of curing agents are materials selected from aliphatic or aromatic amines or their respective adducts, amidoamines, polyamides, cycloaliphatic amines, (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), sulfur or mixtures thereof. Particular preferred curing agents include modified and unmodified polyamines or polyamides such as triethylenetetramine, diethylenetriamine tetraethylenepentamine, cyanoguanidine, dicyandiamides and the like. An accelerator for the curing agents (e.g., a modified or unmodified urea such as methylene diphenyl bis urea, an imidazole or a combination thereof) may also be provided for preparing the activatable material. Other example of curing agent accelerators include, without limitation, metal carbamates (e.g., copper dimethyl dithio carbamate, zinc dibutyl dithio carbamate, combinations thereof or the like), disulfides (e.g., dibenzothiazole disulfide)

Though longer curing times are also possible, curing times of less than 5 minutes, and even less than 30 seconds are possible. Moreover, such curing times can depend upon whether additional energy (e.g., heat, light, radiation) is applied to the material or whether the material is cured at room temperature.

As suggested, faster curing agents and/or accelerators can be particularly desirable for shortening the time between onset of cure and substantially full cure (i.e., at least 90% of possible cure for the particular activatable material) and curing the activatable material while it maintains its self supporting characteristics. As used herein, onset of cure is used to mean at least 3% but no greater than 10% of substantially full cure. For the present invention, it is generally desirable for the time between onset of cure and substantially full cure to be less than about 30 minutes, more typically less than about 10 minutes and even more typically less than about 5 minutes and still more typically less than one minute. It should be noted that more closely correlating the time of softening of the polymeric materials, the time of curing and the time of bubble formation or blowing can assist in allowing for activation of the expandable material without substantial loss of its self supporting characteristics. Generally, it is contemplated that experimentation by the skilled artisan can produce desirable cure times using various of the curing agents and/or accelerators discussed above or others. It has been found that for a dicyanamide curing agent or other agents used for cure during activation, other curing agents or accelerators such as a modified polyamine (e.g., cycloaliphatic amine) sold under the tradename ANCAMINE 2441 or 2442 or 2014 AS; an imidazole (e.g., 4-Diamino-6[2′-methylimidazoyl-(1′)ethyl-s-triazine isocyanuric) sold under the tradename CUREZOL 2MA-OK; an amine adduct sold under the tradename PN-23, an adipic hydrazide sold under the tradename ADH all commercially available from Air Products or an adduct of imidazole and isocyanate sold under the tradename LC-65 and commercially available from A & C Catalyst can produce particularly desirable cure times.

Also as suggested previously, the activatable material can be formulated to include a curing agent that at least partially cures the activatable material prior to activation of the material. Preferably, the partial cure alone or in combination with other characteristics or ingredients of the activatable material imparts sufficient self supporting characteristics to the activatable material such that, during activation and/or foaming, the activatable material, expands volumetrically without significantly losing it shape or without significant flow in the direction or gravity.

In one embodiment, the activatable material includes a first curing agent and, optionally, a first curing agent accelerator and a second curing agent and, optionally, a second curing agent accelerator, all of which are preferably latent. The first curing agent and/or accelerator are typically designed to partially cure the activatable material during processing (e.g., processing, mixing, shaping or a combination thereof of the activatable material for at least assisting in providing the activatable material with the desirable self supporting properties. The second curing agent and/or accelerator will then typically be latent such that they cure the activatable material upon exposure to a condition such as heat, moisture or the like.

As one preferred example of this embodiment, the second curing agent and/or accelerator are latent such that one or both of them cure the polymeric materials of the expandable material at a second or activation temperature or temperature range. However, the first curing agent and/or accelerator are also latent, but either or both of them partially cure the expandable material upon exposure to a first elevated temperature that is below the second or activation temperature.

The first temperature and partial cure will typically be experienced during material mixing, shaping or both. For example, the first temperature and partial cure can be experienced in an extruder that is mixing the ingredient of the activatable material and extruding the activatable material through a die into a particular shape. As another example, the first temperature and partial cure can be experienced in a molding machine (e.g., injection molding, blow molding compression molding) that is shaping and, optionally, mixing the ingredients of the expandable material.

The second or activation temperature and substantially full cure can then at a temperature experienced during processing of the article of manufacture to which the activatable material has been applied. For example, in the automotive industry, e-coat and paint ovens can provide activation temperatures. Typically, it is desirable for the activatable material to additionally expand (e.g., foam) as well as cure at the activation temperature as is described more in detail further below.

Partial cure can be accomplished by a variety of techniques. For example, the first curing agent and/or accelerator may be added to the expandable material in sub-stoichiometric amounts such that the polymeric material provides substantially more reaction sites than are actually reacted by the first curing agent and/or accelerator. Preferred sub-stoichiometric amounts of first curing agent and/or accelerator typically cause the reaction of no more than 60%, no more than 40% or no more than 30%, 25% or even 15% of the available reaction sites provided by the polymeric material. Alternatively, partial cure may be effected by providing a first curing agent and/or accelerator that is only reactive for a percentage of the polymeric material such as when multiple different polymeric materials are provided and the first curing agent and/or accelerator is only reactive with one or a subset of the polymeric materials. In such an embodiment, the first curing agent and/or accelerator is typically reactive with no more than 60%, no more than 40% or no more than 30%, 25% or even 15% by weight of the polymeric materials.

In another embodiment, the activatable material may be formed using a two component system that partially cures upon intermixing of the first component with the second component. In such an embodiment, a first component is typically provided with a first curing agent, a first curing agent accelerator or both and the second component is provided with one or more polymeric materials that are cured (e.g., cross-linked) by the curing agent and/or accelerator upon mixing of the first and second component. Such mixing will typically take place at a temperature below 80° C. (e.g., around room temperature or from about 10° C. to about 30° C.).

Like the previous embodiments, the partial cure, alone or in combination with other characteristics or ingredients of the activatable material, imparts sufficient self supporting characteristics to the activatable material such that, during activation and/or foaming, the activatable material, doesn't experience substantial flow in the direction of gravity.

Also like the previous embodiments, partial cure, upon mixing may be effected by a variety of techniques. For example, the first curing agent and/or accelerator may, upon mixing of the first component and second component, be present within the activatable material in sub-stoichiometric amounts such that the polymeric material[s] provide substantially more reaction sites than are actually reacted by the first curing agent and/or accelerator. Preferred sub-stoichiometric amounts of first curing agent and/or accelerator typically cause the reaction of no more than 60%, no more than 40% or no more than 30%, 25% or even 15% of the available reaction sites provided by the polymeric material. Alternatively, partial cure may be effected by providing a first curing agent and/or accelerator that is only reactive for a percentage of the polymeric material such as when multiple different polymeric materials are provided and the first curing agent and/or accelerator is only reactive with one or a subset of the polymeric materials. In such an embodiment, the first curing agent and/or accelerator is typically capable of reaction with no more than 60%, no more than 40% or no more than 30%, 25% or even 15% by weight of the polymeric material.

The other ingredients (i.e., the additional polymeric materials, filler, other additives, the blowing agents and/or accelerators or the like) of the activatable material may be part of the first or second components of the two component system or may be added separately. Typically, the other additional ingredients will be split between the components in a manner that allows for reasonably thorough mixing of the first component with the second component. Generally, this will help the activatable material to be substantially homogeneous.

The activatable material formed by the two component system can be shaped according any of the techniques described herein (e.g., extrusion through a die, injection molding or the like). According to one preferred embodiment, however, the first and second components are both provided to and mixed within a die that has one or more cavities that shape the activatable material as it is mixed and/or partially cured.

Generally, it is contemplated that any of the curing agents and/or curing agent accelerators discussed herein or others may be used as the first and second curing agents for the activatable materials and the agents or accelerators used will typically depend upon the desired conditions of partial cure and the desired conditions of activation. However, it has been found that, for the first curing agent, hindered amines such as such as a modified polyamine (e.g., cycloaliphatic amine) sold under the tradename ANCAMINE 2337 or 2014 commercially available from Air Products, Inc. are particularly useful. Other desirable first curing agents are those that cure the polymeric materials at temperatures of mixing, formation and/or shaping (e.g., extrusion, molding or the like) of the activatable material. Thus, curing agents that typically cure the polymer materials at temperatures greater than 30° C., but possibly less, more typically greater than 50° C. and even more typically greater than 70° C. and/or temperatures less than 150° C., more typically less than 120° C. and even more typically less than 100° C.

### Filler

The activatable material may also include one or more fillers, including but not limited to particulated materials (e.g., powder), beads, microspheres, or the like. Preferably, the filler includes a relatively low-density material that is generally non-reactive with the other components present in the activatable material.

Examples of fillers include silica, diatomaceous earth, glass, clay, talc, pigments, colorants, glass beads or bubbles, glass, carbon ceramic fibers, antioxidants, and the like. Such fillers, particularly clays, can assist the activatable material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular improved the impact resistance of the cured activatable material.

When employed, the fillers in the activatable material can range from 10% to 90% by weight of the activatable material. According to some embodiments, the activatable material may include from about 0.001% to about 30% by weight, and more preferably about 10% to about 20% by weight clays or similar fillers. Powdered (e.g. about 0.01 to about 50, and more preferably about 1 to 25 micron mean particle diameter) mineral type filler can comprise between about 5% and 70% by weight, more preferably about 10% to about 20%, and still more preferably approximately 13% by weight of the activatable material.

It is contemplated that one of the fillers or other components of the material may be thixotropic for assisting in controlling flow of the material as well as properties such as tensile, compressive or shear strength. Such thixotropic fillers can additionally provide self supporting characteristics to the activatable material. Examples of thixotropic fillers include, without limitation, silica, calcium carbonate, clays, aramid fiber or pulp or others. One preferred thixotropic filler is synthetic amorphous precipitated silicon dioxide.

### Fire Retardant

Typically, the activatable material will include one or more fire retardants, although not required. Useful flame retardants for the activatable material includes, halogenated polymers, other halogenated materials, materials (e.g., polymers) including phosphorous, bromine, chlorine, bromine, oxide, combinations thereof or the like. Exemplary flame retardants include, without limitation, chloroalkyl phosphate, dimethyl methylphosphonate, bromine-phosphorus compounds, ammonium polyphosphate, neopentylbromide polyether, brominated polyether, antimony oxide, calcium metaborate, chlorinated paraffin, brominated toluene, hexabromobenzene, antimony trioxide, graphite (e.g., expandable graphite), combinations thereof or the like.

When used, the fire retardant can be a fairly substantial weight percentage of the activatable material. The fire retardant[s] can comprise greater than 2%, more typically greater than 12%, even more typically greater than 25% and even possibly greater than 35% by weight of the activatable material.

### Other Additives

Other additives, agents or performance modifiers may also be included in the expandable material as desired, including but not limited to a UV resistant agent, a flame retardant, an impact modifier, a heat stabilizer, a UV photoinitiator, a colorant, a processing aid, a lubricant, a reinforcement (e.g., chopped or continuous glass, ceramic, aramid, or carbon fiber or the like).

An exemplary formulation for an expandable or activatable material that can exhibit one or any combination of the aforementioned desirable properties and which has been found to be particularly useful for, amongst other uses, edge closeout is provided in Table A below:

TABLE A

| Description | Percent |
|---|---|
| Polymer of Epoxy Resin and Bisphenol A | 4.65% |
| Carboxy/Acrylonitrile/Butadiene polymer | 2.70% |
| 2-Propenoic acid, 2-methyl-, | 3.42% |
| oxiranylmethyl ester, polymer with ethane | |
| and methyl 2-propenoate | |
| Reaction Product of Epichlorohydrin and | 15.30% |
| Bisphenol A | |
| Epoxy Phenol Novolac Resin | 6.72% |
| Methlene Diphenyl Bis (Dimethyl Urea) | 0.45% |
| Dicyandiamide (Cyanoguanidine) | 1.95% |
| Polymer Encapuslated Isopentane | 6.00% |
| Soda Lime Borosilicate Glass/Amorphous | 18.00% |
| Silicate | |
| Ammonium Polyphosphate | 40.00% |
| Synthetic Amorphous Precipitated Silocon | 0.75% |
| Dioxide | |
| Pigment | 0.10% |

It is contemplated that the weight percentages of the ingredients of Tables A may be raised or lowered by 5, 10, 20, 30, 40 or more percent to form ranges of those ingredients as are suitable for the particular ingredient. For example, an ingredient that is 10 weight percent may be raised or lowered by 20 percent to form a range of 8 to 12 percent. Of course, different compositions of activatable material may be employed within the scope of the present invention particularly if the compositions exhibit one or more of the desired properties. For improving shelf life of the material, it may be desirable to refrigerate the material at a temperature below about 5, 10 or 15° C. although not required unless otherwise stated.

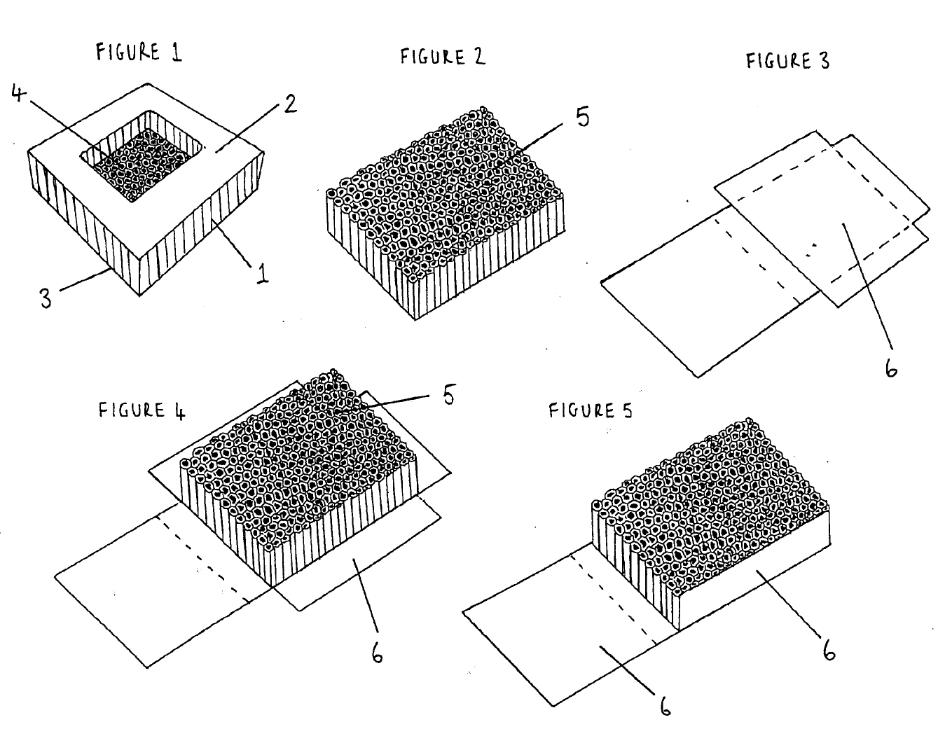

The present invention is illustrated by reference to the accompanying drawings in which FIG. 1 shows a composite material that has been damaged and the damaged area has been removed ready for repair.

FIG. 2 shows a repair patch.

FIG. 3 shows a cut piece of foamable material.

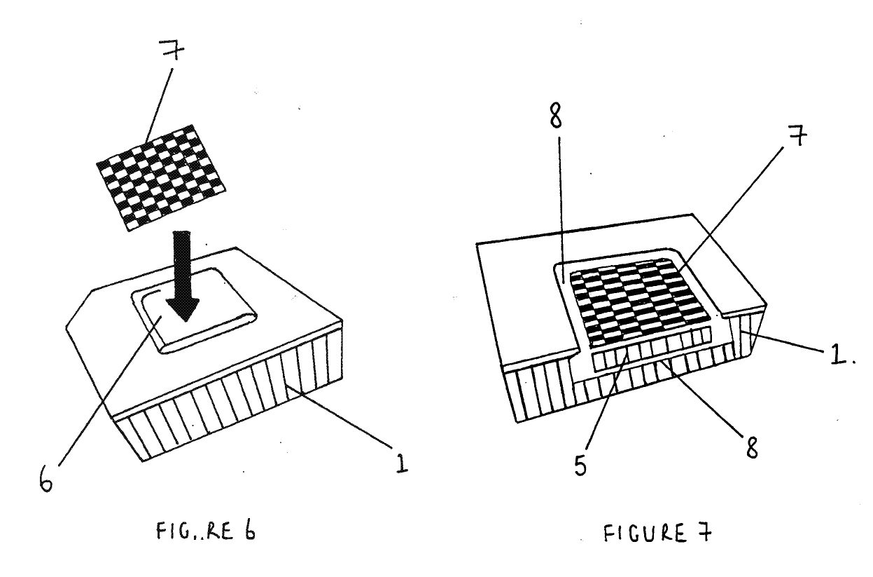

FIGS. 4 and 5 show how to assemble a piece of foamable material as shown in FIG. 3, around the repair patch shown in FIG. 2.

FIG. 6 shows the assembled repair structure inserted into the cavity in the structure shown in FIG. 1 and a patch for the surface material which can also be provided.

FIG. 7 shows the repaired structure.

Referring to FIG. 1 the structure to be repaired comprises a honeycomb structure (1) provided with facing panels (2) and (3). The structure has been damaged and the damaged area has been removed to provide a cavity (4) for the repair of the structure. FIG. 2 shows a honeycomb patch (5) which may or may not be of the same material as the honeycomb structure (1) that has been cut to a size that can readily be inserted into the cavity (4). FIG. 3 shows a piece of a foamable material (6) which has been cut or stamped to a shape that can be assembled around the honeycomb patch (5) as shown in FIGS. 4 and 5. FIG. 5 shows the assembled patch inserted into the cavity (4) and also shows a patch for the facing panel (7) which can be placed on top of the assembled repair patch in contact with the foamable material. FIG. 6 is a cut away view of the repaired material found after the foaming operation showing the honeycomb patch (5) bonded to the honeycomb structure (1) and bonded to the repair patch (7) by means of the foamable material (8).

We have found that the use of a foamable and curable adhesive material enables the production of a strong bond between the two honeycomb structures because as the material foams it can pass into the pores of the honeycomb providing a more rigid structure then can be provided by the use of a surface adhesive.

The structure containing the foamable material and the repair patch can be treated to cause foaming and curing in any suitable manner. The structure may be placed in an oven at an appropriate temperature for foaming and curing. Alternatively, it may pass through heated belts or rollers or it may be heated locally by means of a heated platter or plate. Pressure may be exerted but it should not be sufficient to prevent foaming.

1: A panel structure comprising:
a foamable adhesive material; and
a honeycomb structure;
wherein the foamable adhesive material is bonded to the honeycomb structure.

2: The panel structure according to claim 1 wherein the foamable adhesive material is a material that foams and cures under the application of heat.

3: A process for the repair of a honeycomb structures comprising:
providing a honeycomb bonded to at least one surface layer; and
providing a replacement material for a damaged piece of the honeycomb structure;
wherein the replacement material is bonded to the honeycomb structure by means of a foamable adhesive material.

4: A process according to claim 3 wherein the foamable adhesive is a material that foams and cures under the application of heat.

5: A process according to claim 3 wherein the foamable adhesive is a curable material that is flexible prior to curing and foaming and forms a rigid foam upon curing.

6: A process according to claim 4 further comprising:
providing a patch of the replacement material of the appropriate size enclosed by the foamable material in the cavity around the damaged area; and
foaming and curing the foamable material to form a strong bond between the patch and the honeycomb structure.

7: A process according to claim 3 wherein the honeycomb structure is attached to one or more surface panels.

8: A process according to claim 7 wherein a second patch is provided that is sized so that as the foamable material foams it passes between edges of the second patch and one or more surface panels and cures to form a bond between the two.

9: A process according to claim 3 wherein the foamable material has a post-cure glass transition temperature that is greater than any temperatures to which the material may be exposed while in its intended environment of use.

10: A process according to claim 9 wherein the material is an epoxy-containing material, an ethylene-containing polymer, an acetate or acrylate containing polymer or a mixture thereof.

11: A process according to claim 2 wherein the foamable material is heat activated in a panel press.

12: A process according to claim 8 wherein the honeycomb structure containing the repair material and the one or more surface panels are fed to a panel press where they are subjected to a temperature above 150° F., to cause the material to foam and effect the bond.

13: A process according to claim 12 wherein the honeycomb structure and the one or more surface panels are exposed to a temperature above 150° F. for a period of at least 10 minutes.

14: A process according to claim 3 wherein the foamable material volumetrically expands by at least 10%.

15: A panel structure according to claim 2 wherein the foamable adhesive is a curable material that is flexible prior to curing and foaming and forms a rigid foam upon curing.

16: A panel structure according to claim 2 wherein the honeycomb structure is attached to one or more surface panels.

17: A panel structure according to claim 2 wherein the foamable material has a post-cure glass transition temperature that is greater than any temperatures to which the material may be exposed while in its intended environment of use.

18: A panel structure according to claim 2 wherein the foamable material is an epoxy-containing material, an ethylene-containing polymer, an acetate or acrylate containing polymer or a mixture thereof.

19: A panel structure according to claim 2 in which the foamable material is heat activated in a panel press.

20: A method of repairing a panel structure comprising:
providing a honeycomb structure;
providing one or more surface panels;
providing one or more patches of replacement material;
providing a foamable adhesive material;
bonding the one or more patches of replacement material to a damaged area of the panel and honeycomb structure by means of the foamable adhesive material;
feeding the one or more surface panels and honeycomb structure to a panel press;
exposing the one or more surface panels and honeycomb structure to a temperature above 150° F. so that the foamable adhesive material foams and bonds the honeycomb structure to the one or more surface panels.
